(19) United States
(12) Patent Application Publication
(10) Pub. No.: US 2018/0032955 A1
(43) Pub. Date: Feb. 1, 2018

(54) SYSTEM AND METHOD OF MINIMIZING WAITING TIME IN VEHICLE ROUTING AND SCHEDULING WITH NARROW TIME-WINDOWS

(71) Applicant: SAP SE, Walldorf (DE)

(72) Inventor: Lindawati, Singapore (SG)

(21) Appl. No.: 15/224,687

(22) Filed: Aug. 1, 2016

(51) Int. Cl. G06Q 10/08; G06Q 10/06

(52) U.S. Cl. CPC G06Q 10/08355; G06Q 10/06314

(57) ABSTRACT

A framework for routing and scheduling a fleet of vehicles for servicing a set of requests with narrow time windows that minimizes the total waiting time of the vehicles is provided. In accordance with one aspect, a set of requests associated with narrow time windows for delivering items is received, and route representations representing fleet routes for delivering items for the requests by a fleet of vehicles are generated. A route representation contains numbered nodes, where a unique node number is assigned to a request in the set of request, and each node is assigned with a vehicle number that services the request A sequence of the nodes in the route representation provides an order for servicing the set of requests at the destination locations of the requests by the vehicles in the fleet. Selection, specific crossover and mutation operations are performed iteratively on the route representations to increase feasibility of the route representations. The route representation with the least total waiting time for all the vehicles in the fleet in servicing the delivery requests is output as the optimal solution.

### TECHNICAL FIELD

The present disclosure relates to minimizing waiting time of vehicles in vehicle routing and scheduling with narrow time-windows as hard constraints.

### BACKGROUND

In servicing a delivery request by a customer, customer's expectations in terms of a faster delivery (e.g., same-day pickups and delivery), are as important as price and quality of the items delivered. Satisfying customers delivery expectations is further complicated by narrow delivery time windows. In order to fulfill customer's preferred delivery time windows, a carrier usually needs to manually prioritize the delivery and increase their fleet number to enable less number of deliveries per fleet. In some cases, the fleet drivers spend a substantial idle time waiting for the correct delivery time windows. For example, the fleet drivers may need to spend substantial time to wait from one delivery to another in the previous or current customer locations or even in the road sides.

Therefore, there is a need for a framework that addresses the above-mentioned challenges.

### SUMMARY

A framework for routing and scheduling a fleet of vehicles for servicing a set of requests with narrow time windows that minimizes the total waiting time of the vehicles is provided. In accordance with one aspect, a set of requests associated with narrow time windows for delivering items is received, and route representations representing fleet routes for delivering items for the requests by a fleet of vehicles are generated. A route representation contains numbered nodes, where a unique node number is assigned to a request in the set of request, and each node is assigned with a vehicle number that services the request. A sequence of the nodes in the route representation provides an order for servicing the set of requests at the destination locations of the requests by the vehicles in the fleet. Selection, specific crossover and mutation operations are performed iteratively on the route representations to increase feasibility of the route representations. The route representation with the least total waiting time for all the vehicles in the fleet in servicing the delivery requests is output as the optimal solution.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary system;

FIG. 2 shows an exemplary process for determining an optimal route for a fleet of vehicles that minimize their total waiting time;

FIG. 3 shows an exemplary representation of a fleet route;

FIG. 4 illustrates an exemplary process for generating an initial pool of route representations using a greedy algorithm method;

FIG. 5 illustrates an exemplary process for generating an initial pool of route representations using a random generation method;

FIG. 6 illustrates an exemplary crossover operation; and

FIG. 7 illustrates an exemplary mutation operation.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for minimizing waiting time of vehicles in vehicle routing and scheduling optimization is provided. In accordance with one aspect, the framework minimizes the total waiting time of a fleet of vehicles for servicing delivery requests at a plurality of locations. The delivery requests, in one implementation, may be associated with narrow time window constraints. In one implementation, the framework models the total waiting time of the fleet of vehicles servicing the delivery requests with narrow time window using genetic algorithm. The genetic algorithm is a heuristic technique.

The framework may be used in a logistics problem such as, for example, a delivery problem with narrow time window constraints in supply chain management. For example, the logistics problem may be for optimizing vehicle routing and scheduling for the shipment of items in response to a plurality of delivery requests. The framework determines one or more best or optimal routes that minimize the total waiting time of a fleet of vehicles during the shipment of the items. The framework constructs route representations, each representing a route for a fleet of vehicles. The representations, in one implementation, are generated using the genetic algorithm. The route representation with the least total waiting time for all the vehicles in the fleet in servicing the delivery requests is output as the optimal solution. In some implementations, the framework employs crossover and mutation operations to increase feasibility of the solutions. The framework solves the delivery problem using the genetic algorithm and outputs the optimal solution.

It should be appreciated that the framework described herein may be implemented as a method, a computer-controlled apparatus, a computer process, a computing system, or as an article of manufacture such as a computer-usable medium. These and various other features and advantages will be apparent from the following description.

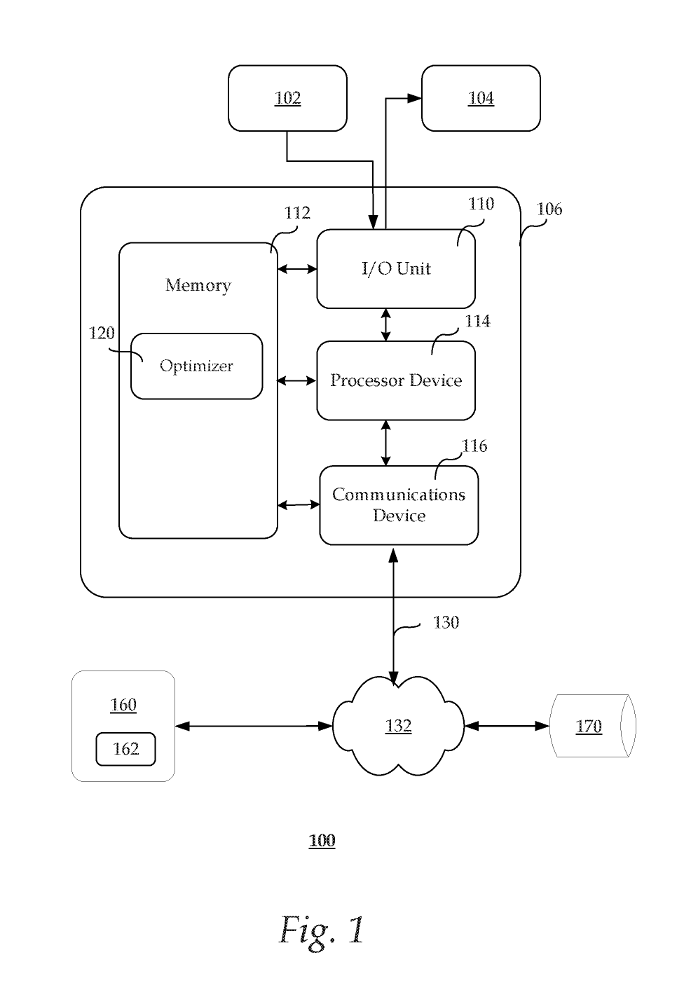

FIG. 1 is a block diagram illustrating an exemplary system 100 in accordance with one aspect of the present framework. The system 100 includes a computer system 106 communicatively coupled to an input device 102 (e.g., keyboard, touchpad, microphone, camera, etc.) and an output device 104 (e.g., display device, monitor, printer, speaker, etc.). Computer system 106 may include a communications device 116 (e.g., a modem, wireless network adapter, etc.) for exchanging data with a network 132 using a communications link 130 (e.g., telephone line, wireless or wired network link, cable network link, etc.) The network may be a local area network (LAN) or a wide area network (WAN). The computer system 106 may be communicatively coupled to one or more client devices 160 via the network. For example, the computer system 106 may act as a server and operate in a networked environment using logical connections to the client devices.

Client devices 160 may include components similar to the computer system 106, and may be in the form of a mobile device, tablet computer, communication device, desktop computer, browser-based device, etc. A user at the client device 160 may interact with a user interface component 162 to communicate with the computer system 106. For example, the interface may be used to access various applications in the computer system 106.

The computer system 106 may be communicatively coupled to one or more data sources 170. The data sources may be, for example, any database (e.g., relational database, in-memory database, etc.), an entity (e.g., set of related records), or data sets or data files included in a database. Alternatively, the database may be stored in a memory module of computer system 106.

The data source contains data or information used by an optimizer 120. In one implementation, the data source contains information of delivery requests, for example, from a plurality of customers. Each delivery request may be associated with inter alia a time window for delivering one or more items to a customer, load size of the delivery, and destination location. Providing other types of information related to the delivery requests may also be useful. Additionally, the data source contains information of one or more depot locations as well as vehicles for servicing the delivery requests. For example, information such as number of vehicles in vehicle fleets, vehicle number, time capacity, volume, weight capacity, demand destination locations, depot locations, delivery time windows, operation hours, delivery load size, may be retrieved from the database of one or more courier companies. Depending on the application, providing other types of data in the data source may also be useful. The type of data collected from the data source may be configured by a user, for example, via the user interface of the client device. For example, information required by the optimizer is configured to be retrieved from the data source. The data stored may be in the form of data structures such as tables and graphical representations. Providing other types of data may also be useful.

It should be appreciated that the different components and sub-components of the computer system 106 may be located on different machines or systems. It should further be appreciated that the components of the client devices 160 may also be located on the computer system 106, or vice versa.

Computer system 106 includes a processor or central processing unit (CPU) 114, an input/output (I/O) unit 110, and a memory module 112. Other support circuits, such as a cache, a power supply, clock circuits and a communications bus, may also be included in computer system 106. In addition, any of the foregoing may be supplemented by, or incorporated in, application-specific integrated circuits. Examples of computer system 106 include a smart device (e.g., smart phone), a handheld device, a mobile device, a personal digital assistance (PDA), a workstation, a server, a portable laptop computer, another portable device, a mini-computer, a mainframe computer, a storage system, a dedicated digital appliance, a device, a component, other equipment, or some combination of these capable of responding to and executing instructions in a defined manner.

Memory module 112 may be any form of non-transitory computer-readable media, including, but not limited to, static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof.

Memory module 112 serves to store machine-executable instructions, data, and various programs, such as an optimizer 120 for implementing the techniques described herein, all of which may be processed by processor device 114. As such, the computer system 106 is a general-purpose computer system that becomes a specific purpose computer system when executing the machine-executable instructions. Alternatively, the various techniques described herein may be implemented as part of a software product. Each computer program may be implemented in a high-level procedural or object-oriented programming language (e.g., C, C++, Java, etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In one implementation, the optimizer 120 generates an optimal solution to a delivery problem with narrow time window constraints. The optimizer, in one implementation, generates one or more delivery routes for a fleet of vehicles, which takes into account a minimized total waiting time by all of the vehicles for servicing a set of delivery requests. The optimizer may use a meta-heuristic algorithm to generate the solution. In one implementation, the optimizer uses a genetic algorithm (GA) to search for the optimal delivery routes for the fleet of vehicles that minimizes their total waiting time during delivery or shipment of items for a set of requests. The optimizer takes the narrow time windows associated to the delivery requests as the hard constraints for generating the optimal solution. The optimal solution may be an optimal route with least total waiting time for the fleet. In some implementation, other constraints such as fleet capacities and operation hours may be used. The optimizer represents and models fleet routes using route representations. The genetic algorithm is applied to iteratively generate pools of route representations as its populations with selection, specific crossover and mutation operations to guarantee feasibility for the generated solutions. The optimizer then reports the optimal solution across all populations via the user interface of the client device. The solution may be a route of the fleet with the least total waiting time in a problem instance.

The optimizer first assumes that the number of fleet of vehicles is sufficient to service a set of delivery requests, N. Additionally, the fleet of vehicles contains homogeneous vehicles with the same volume and weight capacity. Each delivery request i of the set N is associated with a delivery load size qᵢ and destination location vᵢ of the delivery request. A parameter V=P ∪ {v₀} is assigned to represent a set of nodes for the delivery requests, where P={vᵢ ∈ V|i=1, 2, . . . , |N|} represents the destination locations of the delivery requests and node v₀ denotes the depot location where a fleet of vehicles are housed and delivery requests are consolidated.

Each vehicle in a set of vehicles M has a volume and weight capacity Q and time capacity T. A vehicle trip starts from the depot v₀ with a set of deliveries vᵢ ⊂ P and end in the depot v₀ with no cargo or delivery item remaining in order to fulfill a same-day delivery policy. For all node pairs i, j ∈ V, representing two destination locations associated to two respective delivery request, parameters dᵢⱼ denotes a non-negative travel distance and tᵢⱼ denotes a non-negative travel time between i and j, where i denotes the first location and j denotes the second location. The parameters dᵢⱼ and tᵢⱼ may be used to calculate the time a vehicle k reaches a location.

In one implementation, the parameter [eᵢ, lᵢ] is used to denote the time window associated to a delivery request i in which the delivery at the location vᵢ needs to be fulfilled, and 0<Iᵢ−eᵢ≦ε, where ε a is a small number (e.g., 10 to 30). For example, the time window is a narrow time window provided by the customer requesting for the service. If a vehicle k reaches location of the request i before eᵢ, it needs to wait for a wait time wᵢ until eᵢ to deliver the item to fulfil request i. If a vehicle k reaches of the request i after Iᵢ, a delivery request cannot be fulfilled. A delivery route Rₖ for vehicle k is a directed route for a set of deliveries vᵢ ⊂ P such that (1) it starts and ends in v₀, (2) vehicle k visits location of each request i exactly once, (3) the vehicle load at any one time never exceeds Q, (4) the arrival time Aᵢ and departure time Dᵢ of the vehicle at any location of a request i satisfy Dᵢ ∈ [eᵢ, Iᵢ] where Dᵢ=max {Aᵢ, eᵢ) and

$${w}_{i} = \{ \begin{matrix}{e}_{i} - {A}_{i} , {A}_{i} < {e}_{i} \\ 0 , {A}_{i} \geq {e}_{i}\end{matrix} .$$

The optimizer defines a route and scheduling optimization in a delivery problem with narrow time windows as minimizing wait time wᵢ using the following constraints:

∀ i ∈ N, Σₖ₌₁^{M}Zᵢₖ=1 (1)

∀ i ∈ V, Σₖ₌₁^{M}Σⱼ₌₁^{V}xᵢⱼₖ=1 (2)

∀ k ∈ M, Σᵢ₌₁^{V}xᵢ₀ₖ=1 (3)

∀ k ∈ M, Σⱼ₌₁^{V}x₀ⱼₖ=1 (4)

(∀ h ∈ V)(∀ K ∈ M), Σᵢ₌₁^{V}xᵢₕₖ−Σⱼ₌₁^{V}xₕⱼₖ=0 (5)

(∀ j ∈ V)(∀ k ∈ M), Σᵢ₌₁^{V}xᵢⱼₖQ≧yⱼ (6)

(∀ j ∈ V)(∀ k ∈ M), xᵢⱼₖ=1→yᵢ=qᵢ=yⱼ (7)

y₀=0 (8)

(∀ i ∈ V), yᵢ≧0 (9)

(∀ h ∈ V)(∀ k ∈ M), xᵢⱼₖ=1→Dᵢ≦lᵢ (10)

where Z denotes the assignment flag for a delivery to a vehicle, the value will be 1if it is assigned and 0 if it is not assigned, x denotes the visiting flag for a location j by a vehicle k to fulfill a delivery request i, y denotes total capacity of the delivery requests, Q denotes a truck's capacity, q denotes capacity for each demand, l denotes the vehicle's operation hour.

Constraint (1) ensures that each delivery request is assigned to exactly one vehicle. Constraint (2) ensures that each delivery request is visited or serviced exactly once at its respective destination location. Constraints (3) and (4) ensure that each vehicle departs from and return to the depot. Constraint (5) ensures that if a vehicle arrives at a location denoted by node h then it must also depart from that location, Constraints (6) to (9) refer o capacity constraints. Constraint (10) ensures a delivery request is fulfilled within its time window The constraints (1)-(10) may be used to determine the feasibility of a particular solution.

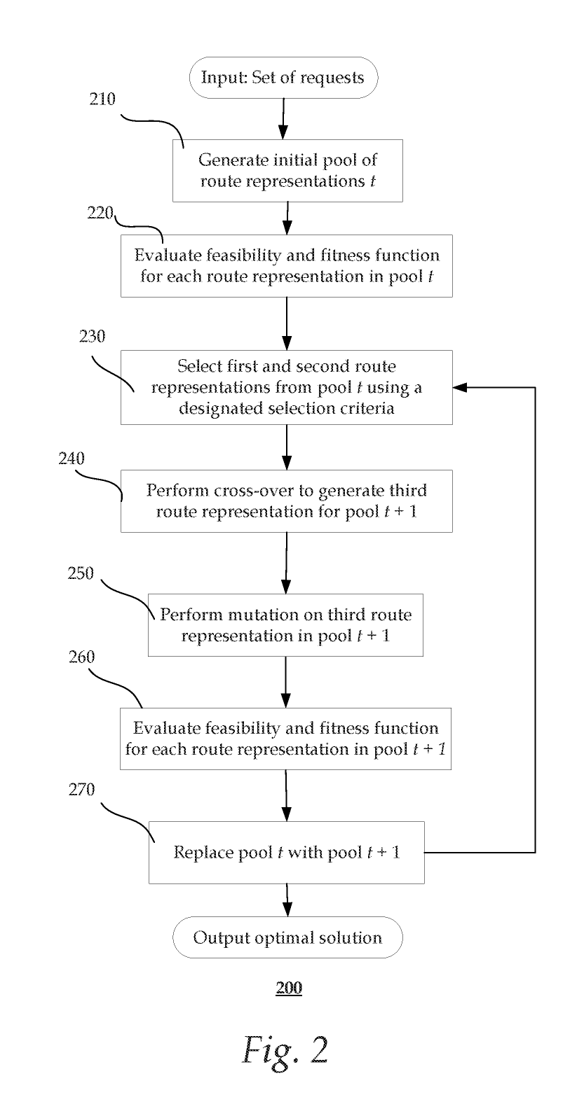

FIG. 2 shows an exemplary process 200 for determining an optimal route for a fleet of vehicles that minimize their total waiting time in servicing a set of requests. For example, a logistics service provider has various options of routes to take in delivering goods to all the different locations of the delivery requests. A location of a delivery request may be connected to other locations using a combination of different routes. The process uses a genetic algorithm to determine the optimal route for the fleet of vehicles in servicing the requests. The optimal route is determined while taking into account narrow time windows associated to each delivery request as the hard constraint. The optimizer starts by generating an initial pool of route representations and continuously generates new pools of route representations from the initial pool over an iteration process to find a better solution.

In the process 200, each route representation in the pool represents possible fleet routes of a fleet of vehicles. A route representation representing a fleet route is given by an integer string of length N, where N is the number of delivery requests that need to be serviced in an instance. For simplicity of discussion, an assumption is made where each customer has one delivery request. As such, the term a customer and a delivery request may be used interchangeably herein.

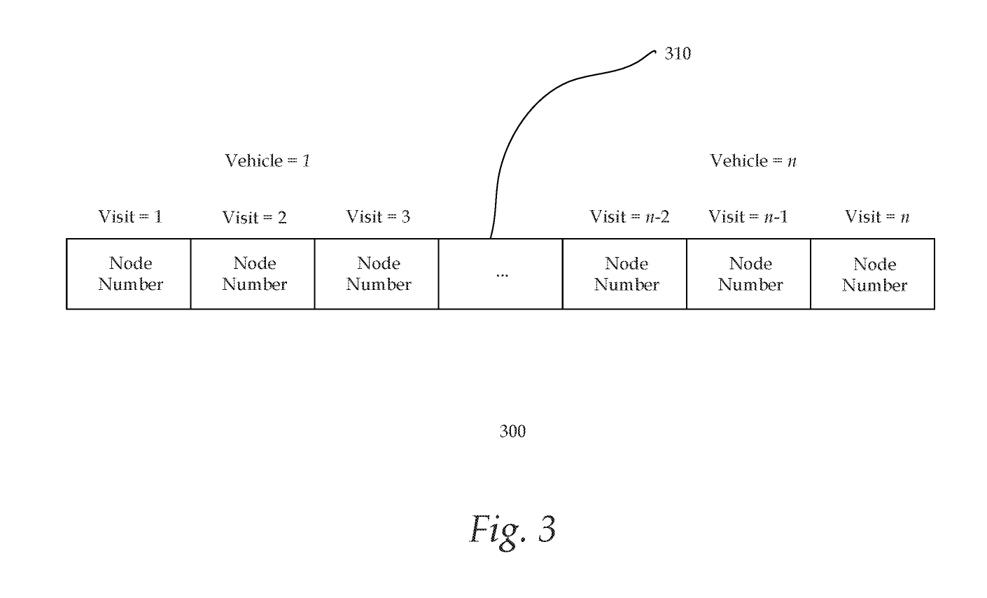

FIG. 3 shows an exemplary route representation 310 of a fleet of vehicles for delivering items to a plurality of destination locations of a set of requests. The route representation contains numbered nodes which are arranged in sequence, where a unique node number is assigned to a request in the set of delivery request. For example, a route representation contains N member of nodes representing the number of delivery requests in the set of delivery requests N. As shown, the nodes are arranged in sequence in the route representation. The sequence of nodes in the route representation is the order of servicing the requests. For example, the sequence of nodes represents the order of visiting the destination locations of the requests by the vehicles in the fleet. No delimiter is used to indicate the beginning or end of a route for individual vehicles but each node records the vehicle number that services it.

The optimizer receives as input a set of requests N. At 210, the initial pool of route representations may be generated using greedy and random methods. The greedy method ensures as many feasible solutions as possible while the random method maintains the randomness in the solutions. Each method is employed to generate half of the initial pool. For example, half of the initial pool may be generated using the greedy method while the remaining half is generated using the random method.

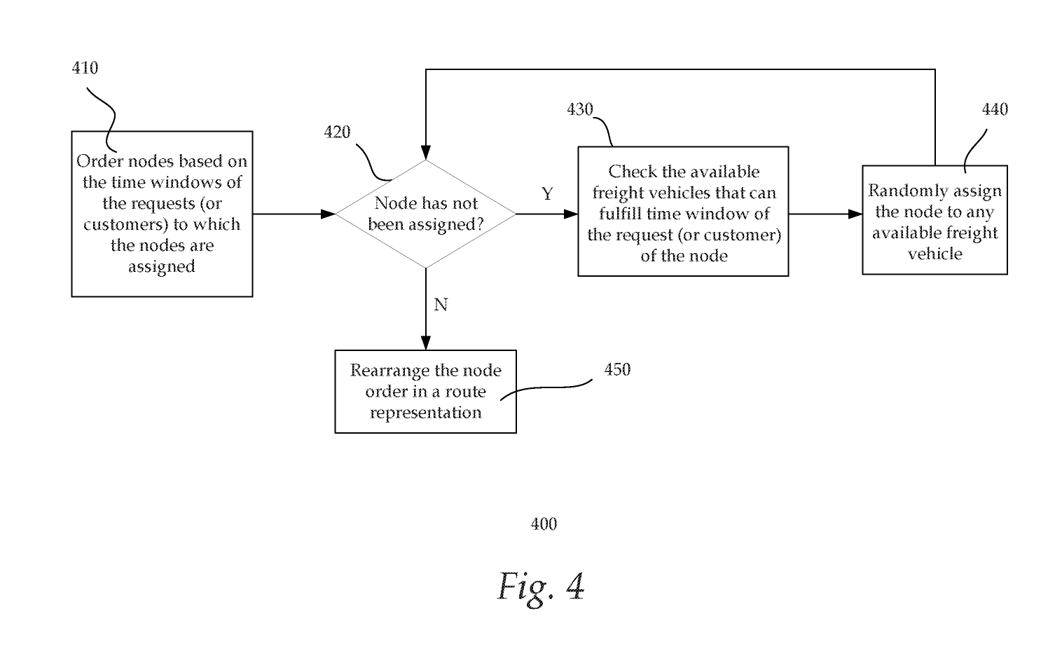

FIG. 4 illustrates an exemplary process 400 for generating an initial pool using a greedy algorithm method. At 410, the optimizer orders the nodes assigned to the delivery requests of a set of delivery requests N in a route representation based on their associated time windows. At 420, the optimizer determines whether a node of a delivery request i has not been assigned to the route representation. If yes, at 430, the optimizer checks the available fleet of vehicles that can fulfill the time window associated to the request which the node is assigned to. At 440, the optimizer randomly assigns the node of the delivery request i to any available vehicle which fulfills the time window associated to the request i. The process then returns to step 420 until all nodes have been assigned in the route representation. At 450, the optimizer rearranges the order of the nodes in the route representation.

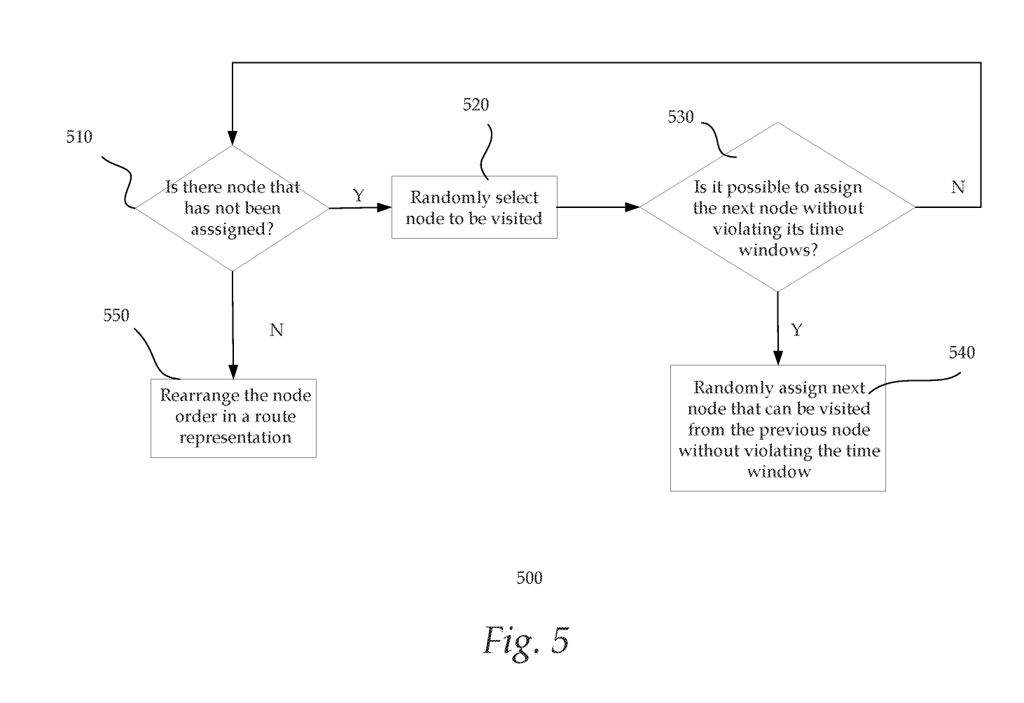

FIG. 5 illustrates an exemplary process 500 for generating an initial pool using a random generation method. At 510, the optimizer determines whether a node of a delivery request i has not been assigned in a route representation. If yes, at 520, the optimizer randomly selects a node of a delivery request to be visited in the route. At 530, the optimizer determines whether it is possible to assign the next node without violating its associated time window If yes, at 540, the optimizer randomly assigns the next node that can be visited from the node without violating the time window. If no, the optimizer return to step 510 to determine other nodes which has not been assigned to the route representation. At 560, the optimizer rearranges the order of the nodes in the route representation.

Returning to FIG. 2, the optimizer evaluates the feasibility and fitness function for each route representation in the pool of route representations t at 220. For example, the feasibility of a route representation or solution may be determined using the constraints (1)-(10) as described earlier. A feasible solution cannot violate any of the constraints (1)-(10). The fitness function for each route representation is evaluated in terms of its (1) objective function value for the feasible soluation and (2) objective function value plus penalized value for the infeasible solution. For example, the sum of wait time wᵢ of the fleet of vehicles is used as the objective value. The penalized value may be set as a fixed large number. The fitness function is described in, for example, Ombuki, Beatrice, Brian J. Ross, and Franklin Hanshar, “Multi-objective genetic algorithms for vehicle routing problem with time windows”. Applied intelligence 24.1, 17-30 (2006), which is herein incorporated by reference. The optimal solution is a feasible solution with minimum fitness function.

At 230, the optimizer selects first and second route representations from the pool of route representations t as parents using a designated selection criteria. The route representations in a pool are selected as parents to reproduce a third route representation. The third route representation is a new route representation generated based on the first and second route representations. In one implementation, the route representations with good fitness function are selected in preference to route representations with poor fitness function. For the selection criteria, a tournament selection is employed. The tournament selection chooses two route representations from the pool of route representations t randomly and compares their fitness value. For example, the route representation with the higher fitness value is selected as the first route representation. The selection is performed twice to obtain the first and second route representations from the pool of route representations.

At 240, the optimizer performs a crossover operation to generate new route representations (e.g., resulting third route representations) from be selected first and second route representations. The crossover operation exchanges subparts of the route representations from the two selected route representations (i.e., a recombination between the first and second route representations) while preserving the feasibility of the resulting third route representation. For example, the optimizer generates the new route representations using nodes from the first and second route representations based on a crossover point.

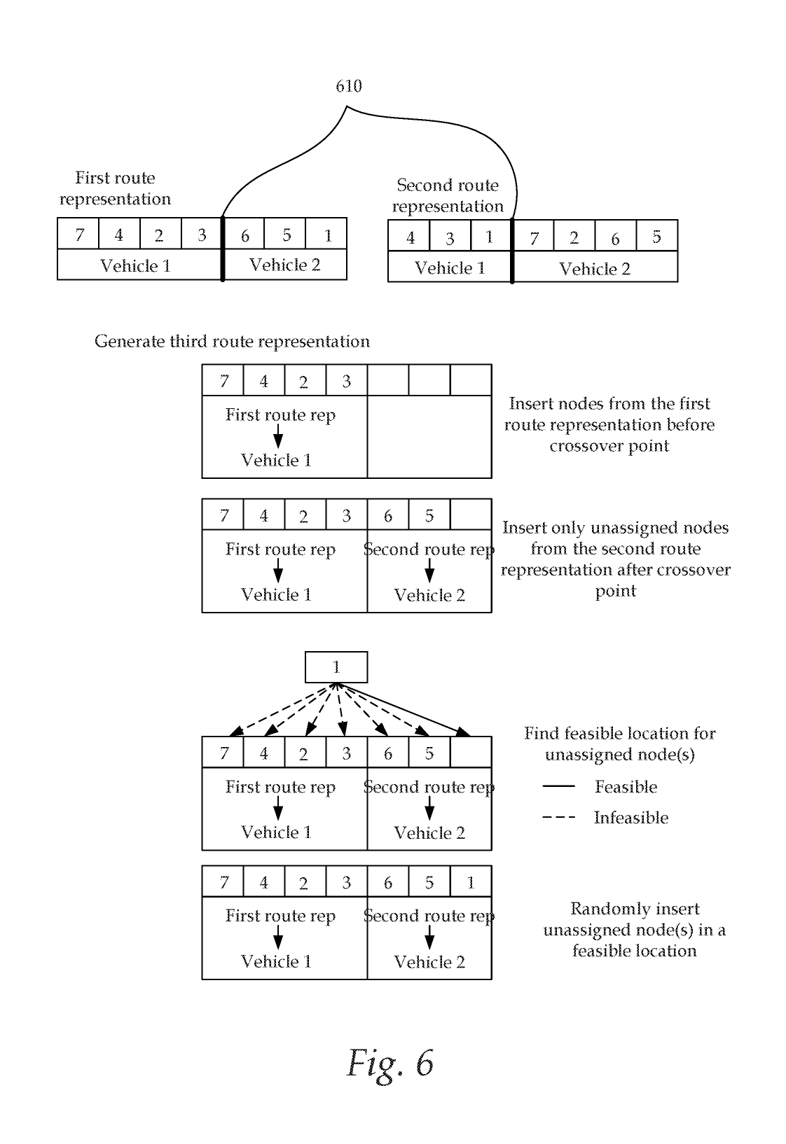

In one implementation, the optimizer selects a random crossover point 610 in the crossover operation, as illustrated in FIG. 6. The crossover point is based on vehicle number. For example, the crossover operation separates a route representation to two portions at the crossover point based on vehicle. All nodes of delivery requests before the crossover point in the first route representation is assigned to the new route representation (e.g., third route representation), followed by assignment of nodes after the crossover point in the second route representation which have not been assigned the new route representation. Since all the delivery requests in the set N needs to be serviced, unassigned nodes are inserted into the new route representation by finding the best possible location for the unassigned nodes and randomly inserting it in the best feasible location. In order to maintain the feasibility of the solution, the nodes may need to be re-arranged to ensure that all deliveries are fulfilled within the time windows. The generated resulting route representation forms part of a new population or pool of route representations t+1.

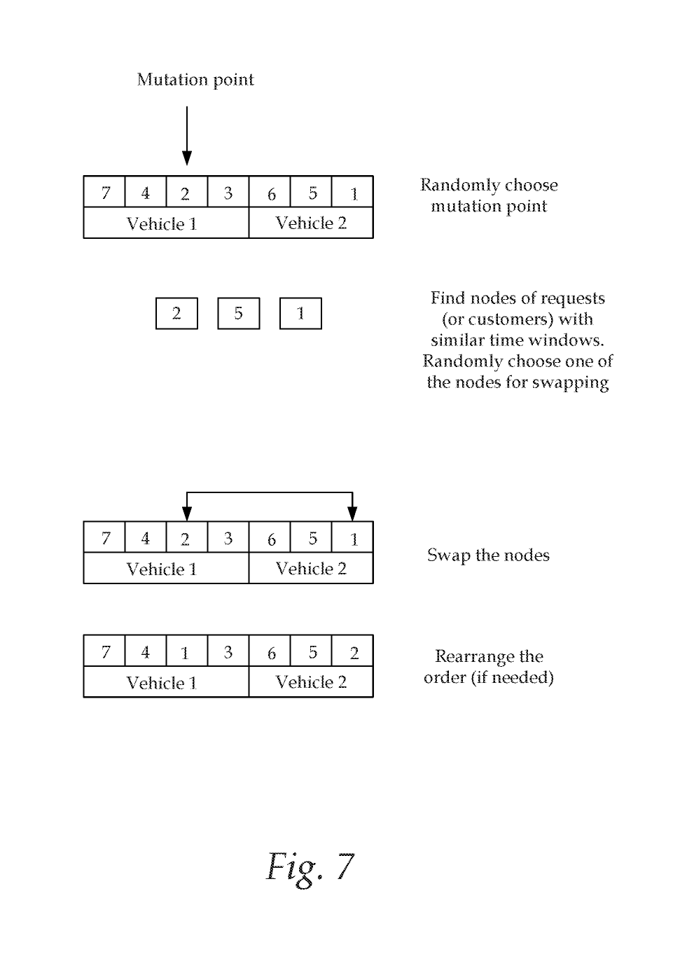

At 250, the optimizer performs a mutation operation on the generated new route representations (or third route representations) in population t+1. To diversify the third route representations from the first and second route representations from which it is generated and maintain feasibility of the new route representation, a mutation operation is applied with a given probability. The mutation operation swaps two nodes that have similar time windows as illustrated in FIG. 7. The mutation operation works randomly to select one node of a delivery requests from the third route representation. Another node of a delivery request with similar time windows is then searched. If there is more than one delivery request with similar time windows, a delivery request is randomly choosen for swapping. After swapping, the route representation may be rearranged.

At 260, the optimizer evaluates the feasibility and fitness function for each route representation in pool t+1. At 270, the optimizer replaces the initial pool t with the pool t+1, and repeats steps 230 to steps 270 to iteratively generate new pools of route representations. The number of iterations a may be set by a user. The optimizer then outputs the optimal solution of a fleet route with minimized total waiting time for all the vehicles in the fleet. The optimization engine provides the best solution to the user via the user interface of the user interface component 162.

An experiment was carried out to determine the performance of the genetic procedure. The following three genetic algorithm parameters were employed: (1) populationSize, (2) crossOverPoint and (3) mutationRate. The cross over point and mutation rate parameters in the genetic algorithm represents the probability for performing a cross over or mutation operation. In the experiment, random parameter values were evaluated. For example, 10 random parameter values were evaluated by running the algorithm and examining the best solution achieved. The parameter values with the best solution were choosen as the value for each parameter as illustrated in Table 1.

TABLE 1

| Parameter | Description | Value |
|---|---|---|
| populationSize | Population size | 500 |
| crossOverPoint | Probability of crossover point | 0.7 |
| mutationRate | Probability to run mutation for resulting route | 0.03 |
| | representation generated from first and second | |
| | route representations | |

The number of generation is set to 500 and the procedure is run for 100 iterations. The best found solution in each iteration is recorded. In the experiment, 10 problem instances were randomly generated with number of customers (or delivery requests) ranging from 10 to 100 extracted from real delivery demand data in Singapore. The distance between two customers is assumed to be the same in each opposite direction and each customer can be visited from all other customers, forming an undirected complete graph. Since most of the real delivery demand data do not have time-windows, narrow time-windows between 10 to 30 minutes are generated to test the performance of the genetic procedure. The number of vehicles is calculated using greedy algorithm to fulfill the time windows for all delivery demands.

The results of the genetic procedure are compared with the optimum solutions generated from an exact algorithm. The run time of the exact algorithm is set to 2 hours. Due to exact algorithm limitation, the exact algorithm can only produce the optimum solution for small instances, for example, problem instances with number of customers 10 and 20. For large instances, the results of the genetic procedure are compared with manual assignment based on delivery location.

Table 2 shows the average best found solution from each iteration and the comparison with the optimum solutions. The result shows that the genetic procedure is able to produce the optimum solutions within a short time period (less than 10% from the time need for the exact algorithm). With large problem sizes, it is difficult to find and prove an optimal solution using exact algorithm, especially within a short computation time.

TABLE 2

| | | | | Genetic Algorithm | |
|---|---|---|---|---|---|
| Number | | Exact Algorithm | | Obj. | |
| of | Number of | Obj. Value | Time | Value | Time |
| vehicles | customers | Found | (second) | Found | (second) |
| 2 | 10 | 0 | 300 | 0 | 25 |
| 4 | 20 | 32 | 1250 | 32 | 52 |
| 7 | 30 | — | — | 239 | 72 |
| 7 | 40 | — | — | 34 | 94 |
| 10 | 50 | — | — | 152 | 125 |
| 11 | 60 | — | — | 151 | 144 |
| 11 | 70 | — | — | 189 | 178 |
| 15 | 80 | — | — | 851 | 205 |
| 14 | 90 | — | — | 388 | 225 |
| 17 | 100 | — | — | 440 | 261 |

### GA Comparison Result with Exact Algorithm

For large instance, the average best found solution for each iteration and its improvement from manual assignment based on delivery location is shown in Table 3. The result shows that the genetic procedure is able to improve the manual assignment by decreasing the average wait time by more than 74% on average.

TABLE 3

| Number | | Manual | Genetic Algorithm | |
|---|---|---|---|---|
| of | Number of | Assignment | Obj. Value | Improvement |
| vehicles | customers | Wait Time | Found | (%) |
| 2 | 10 | 85* | 0 | 100.00 |
| 4 | 20 | 238* | 32 | 86.55 |
| 7 | 30 | 690* | 239 | 65.36 |
| 7 | 40 | 475* | 34 | 92.84 |
| 10 | 50 | 649* | 152 | 76.58 |
| 11 | 60 | 789* | 151 | 80.86 |
| 11 | 70 | 684* | 189 | 72.37 |
| 15 | 80 | 1393* | 851 | 38.91 |
| 14 | 90 | 1033* | 388 | 62.44 |
| 17 | 100 | 1236* | 440 | 64.40 |

*= There are one or more deliveries that violates the time windows.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method for routing and scheduling a fleet of vehicles for servicing a set of requests with narrow time windows that minimizes the total waiting time of the vehicles, comprising:
(i) receiving a set of requests N, wherein each request is associated with a time window constraint for delivering one or more items to a destination location of the request;
(ii) generating, by a processor, route representations of a pool of route representations t, wherein a route representation represents at fleet route, the route representation contains numbered nodes, wherein a unique node number is assigned to a request i in the set of request, and each node is assigned with a vehicle number that services the request, a sequence of the nodes in the route representation provides an order for servicing the set of requests N at the destination locations by the vehicles in the fleet;
(iii) selecting first and second route representations from the pool of route representations t;
(v) performing a crossover operation on the selected first and second route representations to generate a third route representation, wherein performing the crossover operation comprises selecting a crossover point in the first and second route representations and exchanging portions of nodes in the first and second route representations based on the crossover point to generate the third route representation, the generated third route representation forms part of a subsequent pool of route representations t+1,
(v) performing a mutation operation on the third route representation to rearrange the nodes in the third route representation for servicing the set of requests N, wherein the mutation operation swaps two nodes in the route representation based on their associated time windows;
(vi) determining feasibility and fitness function for each route representation in the subsequent pool of route representations t+1;
(vii) replacing the pool of route representations t with the subsequent pool of route representations t+1,
iteratively performing steps (iii) to (vii) for a predetermined number of times; and
outputting, on a user interface of the client device, an optimal route of the fleet with the least total waiting time.

2. The method of claim 1 further comprising evaluating the feasibility and fitness function values for each route representation.

3. The method of claim 2 Wherein evaluating the feasibility for each route representation comprises satisfying the following constraints:
∀ i ∈ N, Σₖ₌₁^{M}Zᵢₖ=1 (1)
∀ i ∈ V, Σₖ₌₁^{M}Σⱼ₌₁^{V}xᵢⱼₖ=1 (2)
∀ k ∈ M, Σᵢ₌₁^{V}xᵢ₀ₖ=1 (3)
∀ k ∈ M, Σⱼ₌₁^{V}x₀ⱼₖ=1 (4)
(∀ h ∈ V)(∀ K ∈ M), Σᵢ₌₁^{V}xᵢₕₖ−Σⱼ₌₁^{V}xₕⱼₖ=0 (5)
(∀ j ∈ V)(∀ k ∈ M), Σᵢ₌₁^{V}xᵢⱼₖQ≧yⱼ (6)
(∀ j ∈ V)(∀ k ∈ M), xᵢⱼₖ=1→yᵢ=qᵢ=yⱼ (7)
y₀=0 (8)
(∀ i ∈ V), yᵢ≧0 (9)
(∀ h ∈ V)(∀ k ∈ M), xᵢⱼₖ=1→Dᵢ≦lᵢ (10)

4. The method of claim 3 wherein a delivery route Rₖ for vehicle k in the route representation is a directed route for a set of deliveries, which starts and ends in a depot location v₀, vehicle k visits location of each request i exactly once, the vehicle load at any one time never exceeds Q, the arrival time Aᵢ and departure time Dᵢ of the vehicle at any location of a request i satisfy Dᵢ ∈ [eᵢ, lᵢ], where Dᵢ=max{Aᵢ, eᵢ) and wait time
$${w}_{i} = \{ \begin{matrix}{e}_{i} - {A}_{i} , {A}_{i} < {e}_{i} \\ 0 , {A}_{i} \geq {e}_{i}\end{matrix} .$$

5. The method of claim 2 further comprising determining the fitness functions for each route representation using an objective value for a feasible route representation, and the objective value plus a penalized value for an infeasible route representation.

6. The method of claim 5 wherein the objective value is determined based on the sum of wait time wᵢ of the vehicles in the fleet.

7. The method of claim 2 further comprising selecting the first and second route representations from the pool of route representations based on the fitness function values for the route representations.

8. The method of claim 1 wherein 0<Iᵢ−eᵢ≦ε, where ε is a small number.

9. The method of claim 1 wherein the pool of route representations t is generated using a greedy algorithm method, comprising:
ordering the nodes assigned to the requests of the set of delivery requests N in a route representation based on their associated time windows;
checking the available fleet of vehicles that can fulfill the time window associated to a request i of a node which has not been arranged in the route representation; and
randomly assigning the node of the request i to any available vehicle which fulfills the time window associated to the request i.

10. The method of claim 9 further comprising generating the pool of route representations t using a random generation method.

11. The method of claim 1 wherein selecting the crossover point in the first and second route representations is based on vehicle number.

12. The method of claim 1 wherein the mutation operation swaps two nodes that have similar time windows.

13. The method of claim 1 wherein the mutation operation swaps two nodes that have similar time windows.

14. A system for routing and scheduling a fleet of vehicles for servicing a set of requests with narrow time windows that minimizes the total waiting time of the vehicles, comprising:
a non-transitory memory device for storing computer-readable program code; and
a processor in communication with the memory device, the processor being operative with the computer-readable program code to perform operations comprising
(i) receiving a set of requests N, wherein each request is associated with a time window constraint for delivering one or more items to a destination location of the request;
(ii) generating, by a processor, route representations of a pool of route representations t, wherein a route representation represents a fleet route, the route representation contains numbered nodes, wherein a unique node number is assigned to a request i in the set of request, and each node is assigned with a vehicle number that services the request, a sequence of the nodes in the route representation provides an order for servicing the set of requests N at the destination locations by the vehicles in the fleet;
(iii) selecting first and second route representations from the pool of route representations t;
(iv) performing a crossover operation on the selected first and second route representations to generate a third route representation, wherein the crossover operation comprises selecting a crossover point in the first and second route representations and exchanging portions of nodes in the first and second route representations based on the crossover point to generate the third route representation, the generated third route representation forms part of a subsequent pool of route representations t+1,
(v) performing a mutation operation on the third route representation to rearrange the nodes in the third route representation for servicing the set of requests N, wherein the mutation operation swaps two nodes in the route representation based on their associated time windows;
(vi) determining feasibility and fitness function for each route representation in the subsequent pool of route representations t+1;
(vii) replacing the pool of route representations t with the subsequent pool of route representations t+1;
iteratively performing steps (iii) to (vii); and
outputting, on a user interface of the client device, an optimal route of the fleet with the least total waiting time.

15. The system of claim 14 further comprising evaluating the feasibil and fitness function values for each route representation.

16. The system of claim 15 therein evaluating the feasibility for each route representation comprises satisfying the following constraints:
∀ i ∈ N, Σₖ₌₁^{M}Zᵢₖ=1 (1)
∀ i ∈ V, Σₖ₌₁^{M}Σⱼ₌₁^{V}xᵢⱼₖ=1 (2)
∀ k ∈ M, Σᵢ₌₁^{V}xᵢ₀ₖ=1 (3)
∀ k ∈ M, Σⱼ₌₁^{V}x₀ⱼₖ=1 (4)
(∀ h ∈ V)(∀ K ∈ M), Σᵢ₌₁^{v}xᵢₕₖ−Σⱼ₌₁^{V}xₕⱼₖ=0 (5)
(∀ j ∈ V)(∀ k ∈ M), Σᵢ₌₁^{V}xᵢⱼₖQ≧yⱼ (6)
(∀ i,j ∈ V)(∀ k ∈ M), xᵢⱼₖ=1→yᵢ=qᵢ=yⱼ (7)
y₀=0 (8)
(∀ i ∈ V), yᵢ≧0 (9)
(∀ h ∈ V)(∀ k ∈ M), xᵢⱼₖ=1→Dᵢ≦lᵢ (10)

17. The system of claim 15 further comprising determining the fitness functions for each route representation using an objective value for a feasible route representation, and the objective value plus a penalized value for an infeasible route representation.

18. The system of claim 17 wherein the objective value is determined based on the sum of wait time wᵢ of the vehicles in the fleet.

19. A non-transitory computer-readable medium having stored thereon program code, the program code executable by a computer to perform steps comprising:
(i) receiving a set of requests N, wherein each request is associated with a time window constraint for delivering one or more items to a destination location of the request;
(ii) generating, by a processor, route representations of a pool of route representations t, wherein a route representation represents a fleet route, the route representation contains numbered nodes, wherein a unique node number is assigned to a request i in the set of request, and each node is assigned with a vehicle number that services the request, a sequence of the nodes in the route representation provides an order for servicing the set of requests N at the destination locations by the vehicles in the fleet;
(iii) selecting first and second route representations from the pool of route representations t;
(v) performing a crossover operation on the selected first and second route representations to generate a third route representation, wherein the crossover operation comprises selecting a crossover point in the first and second route representations and exchanging portions of nodes in the first and second route representations based on the crossover point to generate the third route representation, the generated third route representation forms part of a subsequent pool of route representations t+1,
(v) performing a mutation operation on the third route representation to rearrange the nodes in the third route representation for servicing the set of requests N, wherein the mutation operation swaps two nodes in the route representation based on their associated time windows;
(vi) determining feasibility and fitness function for each route representation in the subsequent pool of route representations t+1:
(vii) replacing the pool of route representations I with the subsequent pool of route representations t+1;
iteratively performing steps (iii) to (vii); and
outputting, on a user interface of the client device, an optimal route of the fleet with the least total waiting time.

20. The non-transitory computer-readable medium of claim 19 further comprising evaluating the feasibility and fitness function values for each route representation.
